(19) United States
(12) Patent Application Publication
(10) Pub. No.: US 2026/0178533 A1
(43) Pub. Date: Jun. 25, 2026

(54) INTERFACE CARD DEVICE AND REPAIRING METHOD THEREOF

(71) Applicant: REALTEK SEMICONDUCTOR CORP., HsinChu (TW)

(72) Inventors: Chun-Wei Kao, HsinChu (TW); Yi-Long Chang, HsinChu (TW); Wan-Ju Wu, HsinChu (TW)

(73) Assignee: REALTEK SEMICONDUCTOR CORP., HsinChu (TW)

(21) Appl. No.: 19/361,180

(22) Filed: Oct. 17, 2025

(30) Foreign Application Priority Data
Dec. 24, 2024 (TW) 113150511

(51) Int. Cl. G06F 13/42

(52) U.S. Cl. CPC G06F 13/4221; G06F 2213/0026

(57) ABSTRACT

An interface card device and repairing method thereof is related to the interface card device including a transmission interface, a timing module, and a control module. The transmission interface is electrically connected to a host device. The timing module is electrically connected to the transmission interface. The control module is electrically connected to the transmission interface and the timing module. The transmission interface includes at least one layer corresponding to at least one finite state machine. The timing module is configured to time a state-stop time for any of the at least one finite state machine to stop working, and to generate a reset signal when the state-stop time exceeds a threshold to reset the state-stop time. The control module is configured to switch a state of the at least one finite state machine, and to switch the state to a reset state according to the reset signal.

### CROSS-REFERENCE TO RELATED APPLICATION

This non-provisional application claims priority under 35 U.S.C. § 119(a) to Patent Application No. 113150511 filed in Taiwan, R.O.C. on December 24, 2024, the entire contents of which are hereby incorporated by reference.

### BACKGROUND

### Technical field

The present disclosure relates to a peripheral component interconnect express (PCIe) communication standard, and in particular to an interface card device and a repairing method thereof.

### Related Art

A communication standard is often applied to an external device (hereafter referred to as a PCIe device) of a computer host (hereafter referred to as a host device) to transmit signals. It is needed to construct a transmission channel (hereinafter referred to as a PCIe link) for the PCIe device relative to the host device so as to send signals to the host device or receive signals from the host device. When there is no signal transmitted between the host device and the PCIe device, it indicates that there may be an error in the host device or the PCIe device. In the PCIe communication standard, it defines correctable errors and uncorrectable errors. The uncorrectable errors include fatal errors and non-fatal errors, and the PCIe device cannot self-repair the uncorrectable errors, which must be handled by a platform.

When the fatal error occurs on the PCIe device, the PCIe device must reconstruct the PCIe link to eliminate the fatal error. However, there are still several problems in process of reconstructing the PCIe link. First, there is no clear specification for when the platform steps in. That is, the PCIe device cannot repair the fatal error instantly. In addition, when the uncorrectable error is eliminated, a user cannot know how the uncorrectable error is produced and cannot analyze and debug subsequently. As a result, when the PCIe link is reconstructed, the same error may occur again on either the host device or the PCIe device.

### SUMMARY

In view of this, the inventor provides an interface card device and a repairing method thereof to repair the abovementioned fatal error. In some embodiments, the interface card device includes a transmission interface, a timing module, and a control module. The transmission interface is electrically connected to a host device and includes at least one layer corresponding to at least one finite state machine. The timing module is electrically connected to the transmission interface, and the timing module is configured to time a state-stop time for any of the at least one finite state machine to stop working, and to generate a reset signal and reset the state-stop time when the state-stop time exceeds a threshold. The control module is electrically connected to the transmission interface and the timing module, and the control module is configured to switch a state of the at least one finite state machine, and to switch the state to a reset state according to the reset signal.

In some embodiments, the interface card device further includes a memory module. The memory module is electrically connected to the control module, and the memory module is configured to store the state of the at least one finite state machine when the state-stop time exceeds the threshold.

In some embodiments, the state of the at least one finite state machine includes a detection state, a polling state, a configuration state, a working state, a plurality of low-power-consumption states with different power consumption degrees and a reset state associated with each other.

In some embodiments, each layer of the transmission interface includes a physical layer (PHY), and the PHY includes a physical coding sublayer (PCS), a physical media attachment layer (PMA) and a media access control layer (MAC). The PCS is positioned between the MAC and the PMA, and the finite state machine of the MAC is a link training and status state machine (LTSSM).

In some embodiments, the timing module is a watchdog timer.

In some embodiments, a repairing method of an interface card device includes: monitoring a working of a finite state machine; in response to that the finite state machine stops working, starting to time a state-stop time; in response to that the state-stop time exceeds a threshold, generating a reset signal and resetting the state-stop time; and switching a state of the finite state machine to a reset state according to the reset signal.

In some embodiments, the repairing method further includes: recording the state of the finite state machine when the state-stop time exceeds the threshold.

In some embodiments, the repairing method further includes: driving the finite state machine to start working; and during the working of the finite state machine, sequentially switching the state of the finite state machine from a detection state to a polling state, a configuration state and a working state.

In some embodiments, the repairing method further includes: during the working of the finite state machine, switching the state of the finite state machine from the working state to one of a plurality of low-power-consumption states with different power consumption degrees.

In some embodiments, the repairing method further includes: during the working of the finite state machine, switching the state of the finite state machine back from one of the plurality of low-power-consumption states to the working state.

In conclusion, according to the interface card device and the repair method thereof in any embodiment, the state-stop time is detected to confirm whether the interface card device is subjected to an error, and when the interface card device or the host device is subjected to the error, the state of the finite state machine in the transmission interface can be reset within a specific time (corresponding to the threshold), and thus the interface card device reconstructs the transmission channel relative to the host device so as to eliminate the error. In addition, besides immediately resetting the state, the interface card device and the repairing method thereof can also store the error (namely, the state that the error occurs), so that the user can obtain the information of the error to further perform subsequent analysis and debugging.

### BRIEF DESCRIPTION OF THE DRAWINGS

FIG. 1 is a block diagram of a module in an embodiment of an interface card device.

FIG. 2 is a flowchart of an embodiment of an interface card device in FIG. 1.

FIG. 3 is a schematic diagram of an Embodiment I of a finite state machine in a layer of a transmission interface in FIG. 1.

FIG. 4 is a flowchart of an Embodiment I before step S110 in FIG. 1.

FIG. 5 is a schematic diagram of an Embodiment II of a finite state machine in a layer of a transmission interface in FIG. 1.

FIG. 6 is a flowchart of an Embodiment II before step S110 in FIG. 1.

FIG. 7 is a schematic diagram of a link training and status state machine in a PCIe communication standard.

FIG. 8 is a first schematic diagram of a PCIe communication standard.

FIG. 9 is a second schematic diagram of a PCIe communication standard.

### DETAILED DESCRIPTION

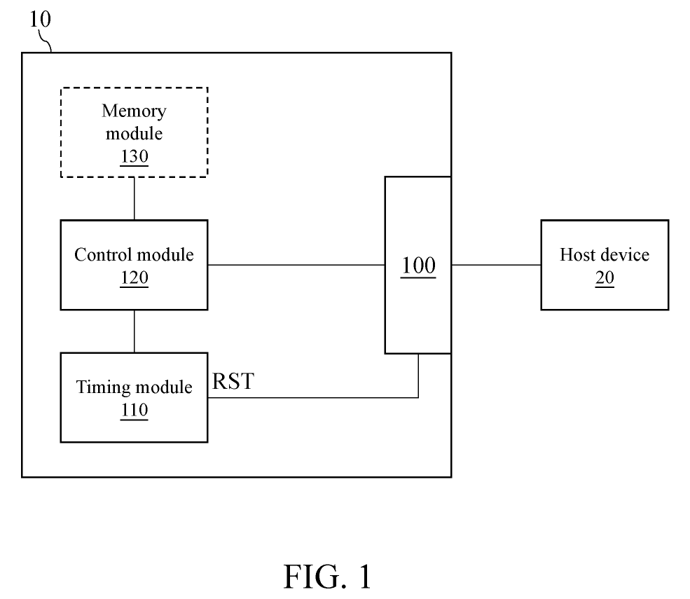

With reference to FIG. 1, an interface card device 10 is connected to a host device 20. As shown in FIG. 1, the interface card device 10 includes a transmission interface 100, a timing module 110 and a control module 120. The timing module 110 is electrically connected to the transmission interface 100, and the control module 120 is electrically connected to the transmission interface 100 and the timing module 110. In some embodiments, the host device 20 can be a hardware element with a slot corresponding to the transmission interface 100, such as, but not limited to, a mainboard, a display card, a demo board, a single-board microcomputer, a desktop computer or a notebook computer.

In some embodiments, the interface card device 10 can be inserted into the slot of the host device 20 through the transmission interface 100, and thus the interface card device 10 can be electrically connected to the host device 20 through the transmission interface 100. That is, the slot of the host device 20 and the transmission interface 100 support the same communication standard.

The transmission interface 100 includes at least one layer corresponding to at least one finite state machine. Therefore, the interface card device 10 constructs a transmission channel relative to the host device 20 through the finite state machine of each layer in the transmission interface 100.

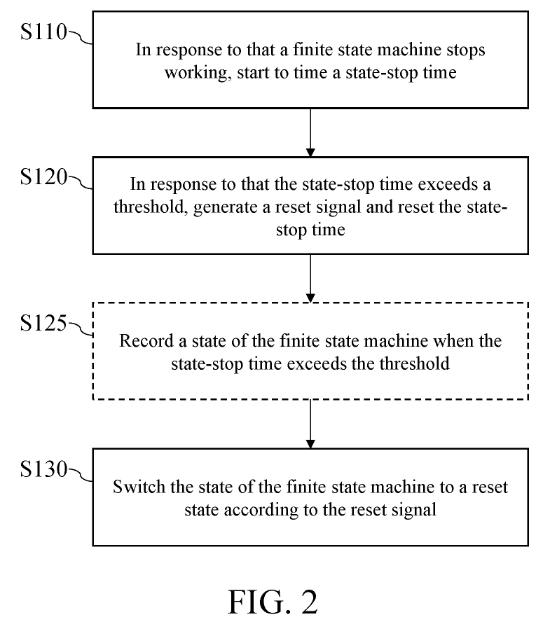

With reference to FIG. 1 to FIG. 3. In order to facilitate description, A work process of the interface card device 10 is described below by taking the transmission interface 100 only including one layer as an example; that is, the work process of the interface card device 10 is described below with a single finite state machine, but it is not intended to limit the number of layers of the transmission interface 100 and the number of finite state machines. In some embodiments, when the interface card device 10 is inserted into the host device 20, the interface card device 10 receives a power signal from the host device 20 and then is powered on. At the moment, the finite state machine of the one layer in the transmission interface 100 is driven to start working, and the control module 120 starts to monitor a working of this finite state machine. Therefore, the transmission channel between the interface card device 10 and the host device 20 is constructed, and the interface card device 10 can send a data signal to the host device 20 or receive the data signal from the host device 20. A construction mode of the transmission channel between the interface card device 10 and the host device 20 will be described later.

During the working of the finite state machine, when the finite state machine stops working, it indicates that there is an error (including a correctable error and an uncorrectable error) in the interface card device 10 or the host device 20. At the moment, in response to that the finite state machine stops working, the timing module 110 starts to time a state-stop time (step S110). In some embodiments, the finite state machine stopping working indicates that the finite state machine cannot normally execute functions corresponding to the state of the finite state machine in current operation. That is, when the finite state machine stops working, the interface card device 10 will stop working at the same time. It is to be noted that when the interface card device 10 includes a plurality of layers and a plurality of corresponding finite state machines, the timing module 110 only needs to time the finite state machine that is stopped working and is out of a low-power-consumption state.

When the timing is overtime (namely the state-stop time exceeds a threshold), in response to that the state-stop time exceeds a set threshold, the timing module 110 generates a reset signal (RST) and resets the state-stop time (step S120). The amplitude of the threshold can be self-defined, such as but not limited to, 1 second, 3 seconds or 5 seconds. It is to be noted that when the interface card device 10 includes the plurality of layers and the plurality of corresponding finite state machines, all the finite state machines need to be recovered to the original state during resetting.

In some embodiments, when the finite state machine is switched to a next state to enable the timing module 110 to start timing again and the state-stop time timed by the timing module 110 does not exceed the threshold, it indicates that there is no error in a system program, and the interface card device 10 will continue to work without influence. Otherwise, when the state-stop time timed by the timing module 110 exceeds the threshold, it indicates that the error cannot be automatically repaired by the interface card device 10 or the host device 20 (corresponding to a fatal error), consequently, the interface card device 10 cannot continue to work.

After step S120, the control module 120 will switch the state of the finite state machine to a reset state St0 according to the reset signal (RST) (step S130), thus the transmission channel between the interface card device 10 and the host device 20 can be reconstructed to eliminate the error. Therefore, the transmission channel between the interface card device 10 and the host device 20 is reconstructed within expected time (corresponding to the threshold) after the error occurs, and the interface card device 10 can normally work.

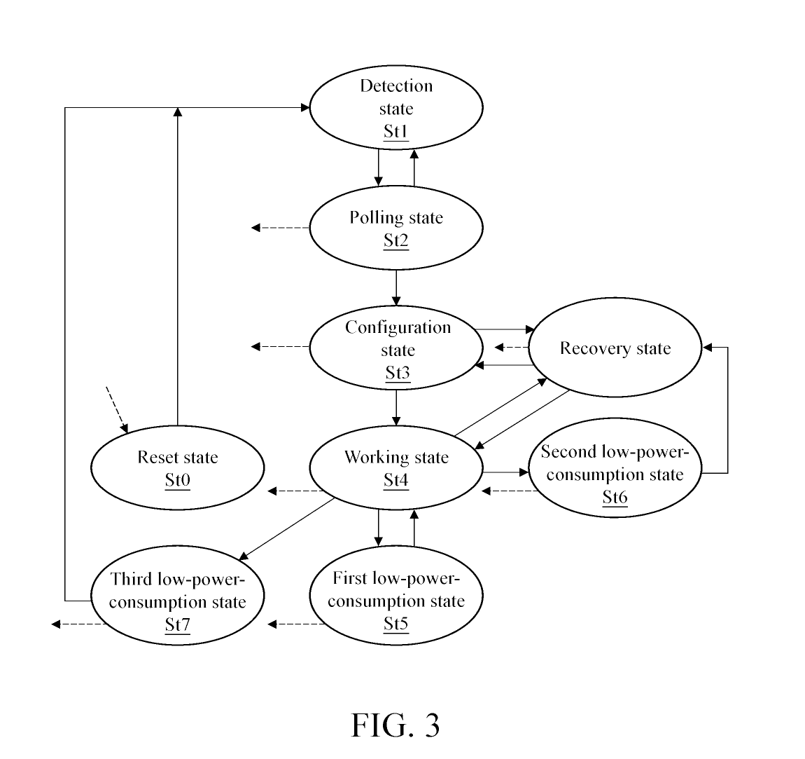

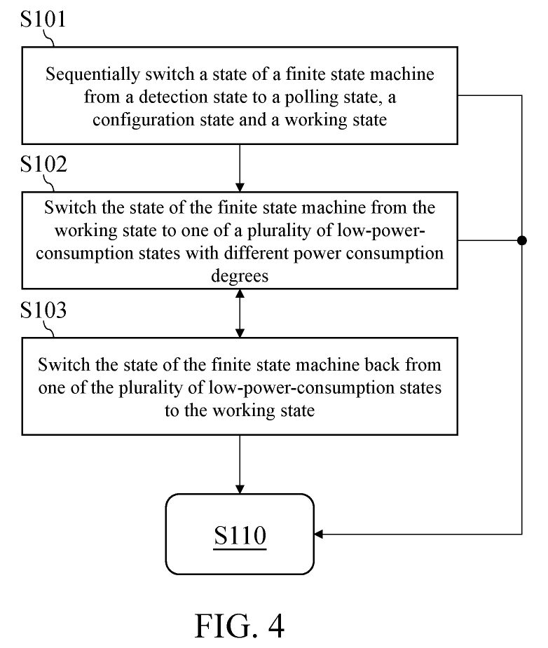

With reference to FIG. 1 to FIG. 4. In some embodiments, the finite state machine works in a plurality of finite states. As shown in FIG. 3, in the embodiment, the finite state machine has a plurality of states St0-St7. The states St0-St7 of the finite state machine include a plurality of states St0-St6, containing a reset state St0, a detection state St1 (Detect), a polling state St2 (Polling), a configuration state St3 (Configuration), a working state St4 and a plurality of low-power-consumption states with different power consumption degrees. Two low-power-consumption states St5 and St6 will be taken as examples for illustrating below, and the low-power-consumption states St5 and St6 are respectively called as a first low-power-consumption state St5 and a second low-power-consumption state St6. In some embodiments, the detection state St1 is an initial state of the finite state machine. In some embodiments, the states St0-St7 of the finite state machine further include a sub-low-power-consumption state (hereinafter referred to as third low-power-consumption state St7).

In some embodiments, the working state St4 corresponds to an L0 state in an active state power management (ASPM) protocol of the PCIe communication standard, the first low-power-consumption state St5 corresponds to an L0s state in the ASPM protocol, the second low-power-consumption state St6 corresponds to an L1 state in the ASPM protocol, and the third low-power-consumption state St7 corresponds to an L2 state in the ASPM protocol. That is, various states defined in the ASPM protocol are suitable for the state of the finite state machine in the interface card device 10. The PCIe communication standard and the ASPM protocol are known for those with common knowledge in the technical field of the present disclosure, and will not be listed here.

During the working of the finite state machine, the control module 120 sequentially switches the state of the finite state machine from the detection state St1 to the polling state St2, the configuration state St3 and the working state St4 (step S101), and thus the finite state machine will sequentially work in the detection state St1, the polling state St2, the configuration state St3 and the working state St4.

In some embodiments, when the finite state machine works in the detection state St1, the control module 120 can detect whether the interface card device 10 is inserted into the host device 20. In some embodiments, when the finite state machine works in the polling state St2, the control module 120 will send a signal to the host device 20 and receives a signal from the host device 20 to confirm whether the transmission interface 100 and a slot of the host device 20 can normally work. In some embodiments, when the finite state machine works in the configuration state St3, the control module 120 can set parameters (such as but not limited to bandwidth, frequency or time sequence) of the transmission interface 100. In some embodiments, when the finite state machine works in the working state St4, it indicates that the construction of the transmission channel between the interface card device 10 and the host device 20 is finished. At the moment, the interface card device 10 can normally communicate with the host device 20 to transmit the signals. Moreover, when the state of the finite state machine sequentially follows the polling state St2, the configuration state St3 and the working state St4 and there is no error in the process, the transmission channel between the interface card device 10 and the host device 20 can be constructed.

In some embodiments, after step S101 (namely, the state of the finite state machine is the working state St4), the control module 120 will switch the state of the finite state machine from the working state St4 to one of the plurality of low-power-consumption states with different power consumption degrees (step S102), and thereby decreasing the power consumption of the interface card device 10. For example, the control module 120 can switch the state of the finite state machine from the working state St4 to the first low-power-consumption state St5 or the second low-power-consumption state St6.

In some embodiments, the difference between the first low-power-consumption state St5 and the second low-power-consumption state St6 is the level of reduced power consumption. For example, when the finite state machine works in any low-power-consumption state (such as the first low-power-consumption state St5 or the second low-power-consumption state St6), the power consumption of the interface card device 10 is lower than that of the interface card device 10 when the finite state machine works in the working state St4; and when the finite state machine works in the second low-power-consumption state St6, the power consumption of the interface card device 10 is lower than that of the interface card device 10 when the finite state machine works in the first low-power-consumption state St5.

In some embodiments, after step S102 (namely, the state of the finite state machine is any low-power-consumption state), the control module 120 will switch the state of the finite state machine back from one of the plurality of low-power-consumption states to the working state St4 (step S103). For example, the control module 120 can switch the state of the finite state machine back from the first low-power-consumption state St5 or the second low-power-consumption state St6 to the working state St4. Therefore, the control module 120 can switch the state of the finite state machine according to different use situations, so that the power consumption of the interface card device 10 can be adjusted to avoid resource waste.

In some embodiments, the interface card device 10 further includes a memory module 130. The memory module 130 is electrically connected to the control module 120, and the memory module 130 is configured to record the state of the finite state machine when the state-stop time exceeds the threshold (step S125). That is, before step S130 (namely, before the state of the finite state machine is reset to the reset state St0), the memory module 130 can store the state of the finite state machine when the state-stop time exceeds the threshold in advance so as to record the current state of the finite state machine when there is an error in the interface card device 10 or the host device 20, thus facilitating to perform software and hardware analysis or debugging programs later.

For example, when the state of the finite state machine is the first low-power-consumption state St5, there is an error in the interface card device 10 or the host device 20. At the moment, the control module 120 can record information related to the error and the first low-power-consumption state St5 into a log file and store the log file into the memory module 130. Therefore, the user can perform corresponding software and hardware analysis or debugging program according to the log file stored in the memory module 130.

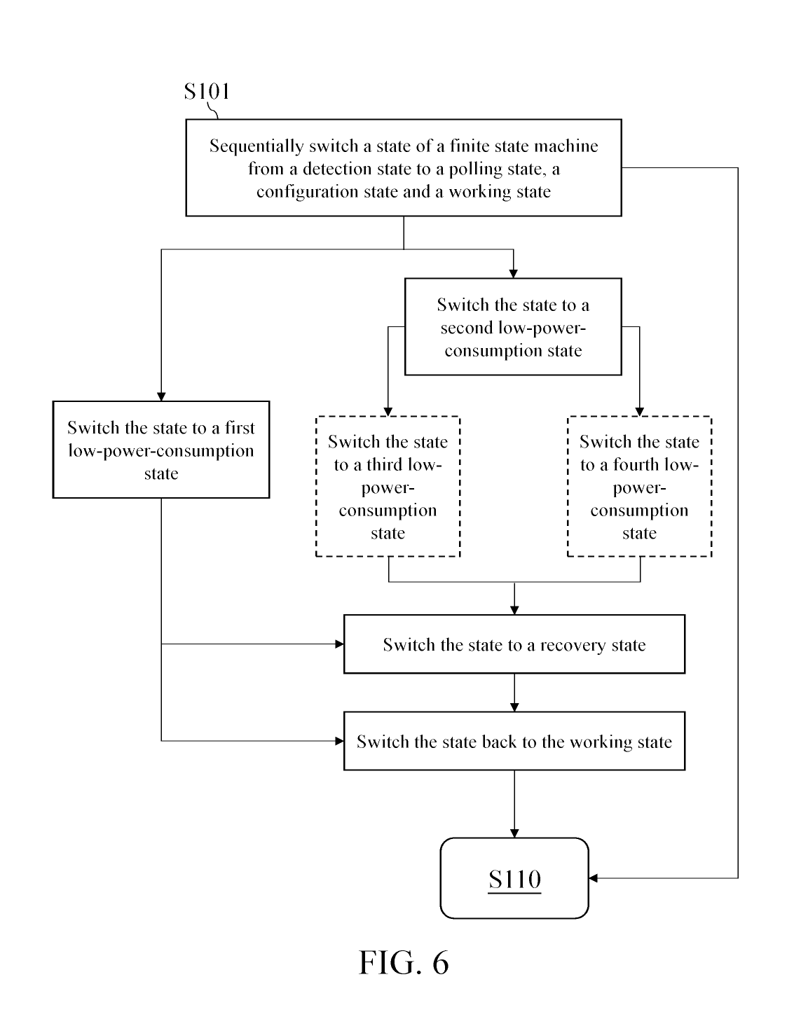

With reference to FIG. 1 to FIG. 3 and FIG. 5 to FIG. 7. In some embodiments, in addition to the states St0-St6, states St0-St8 of the finite state machine also include two sub-low-power-consumption states (hereinafter referred to as a third low-power-consumption state St7 and a fourth low-power-consumption state St8). Therefore, the control module 120 can switch the state of the finite state machine to the third low-power-consumption state St7 and switch the state of the finite state machine to the fourth low-power-consumption state St8 to realize setting of more low-power-consumption modes.

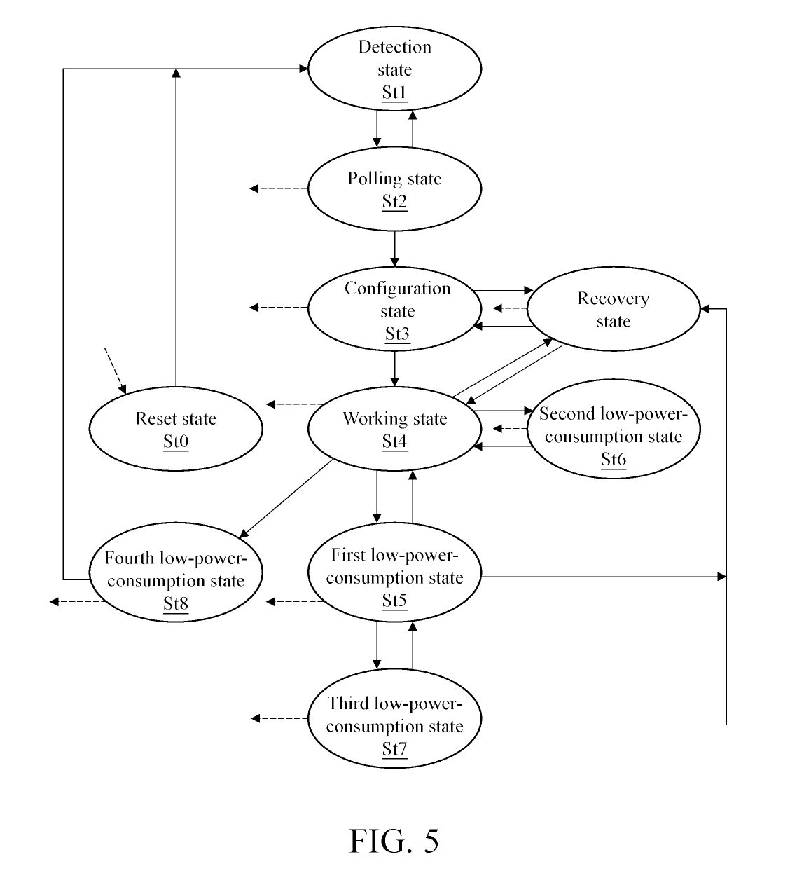

In some embodiments, in step S130, the control module 120 switches the state of the finite state machine to the reset state St0 according to the reset signal (RST). When the finite state machine works in the reset state St0, the control module 120 will interrupt the transmission channel between the interface card device 10 and the host device 20, and switch the state of the finite state machine from the reset state St0 to the detection state St1 so as to reconstruct the transmission channel between the interface card device 10 and the host device 20, thereby eliminating the error in the interface card device 10 or the host device 20. When there is an error in the interface card device 10 or the host device 20 during the working of the finite state machine in any state (such as the detection state St1, the polling state St2, the configuration state St3, the working state St4, entering and exiting the first low-power-consumption state St5, entering and exiting the second low-power-consumption state St6, entering and exiting the third low-power-consumption state St7, and entering and exiting the fourth low-power-consumption state St8), the control module 120 can switch the state of the finite state machine from any state to the reset state St0 (as shown in FIG. 3 and FIG. 5).

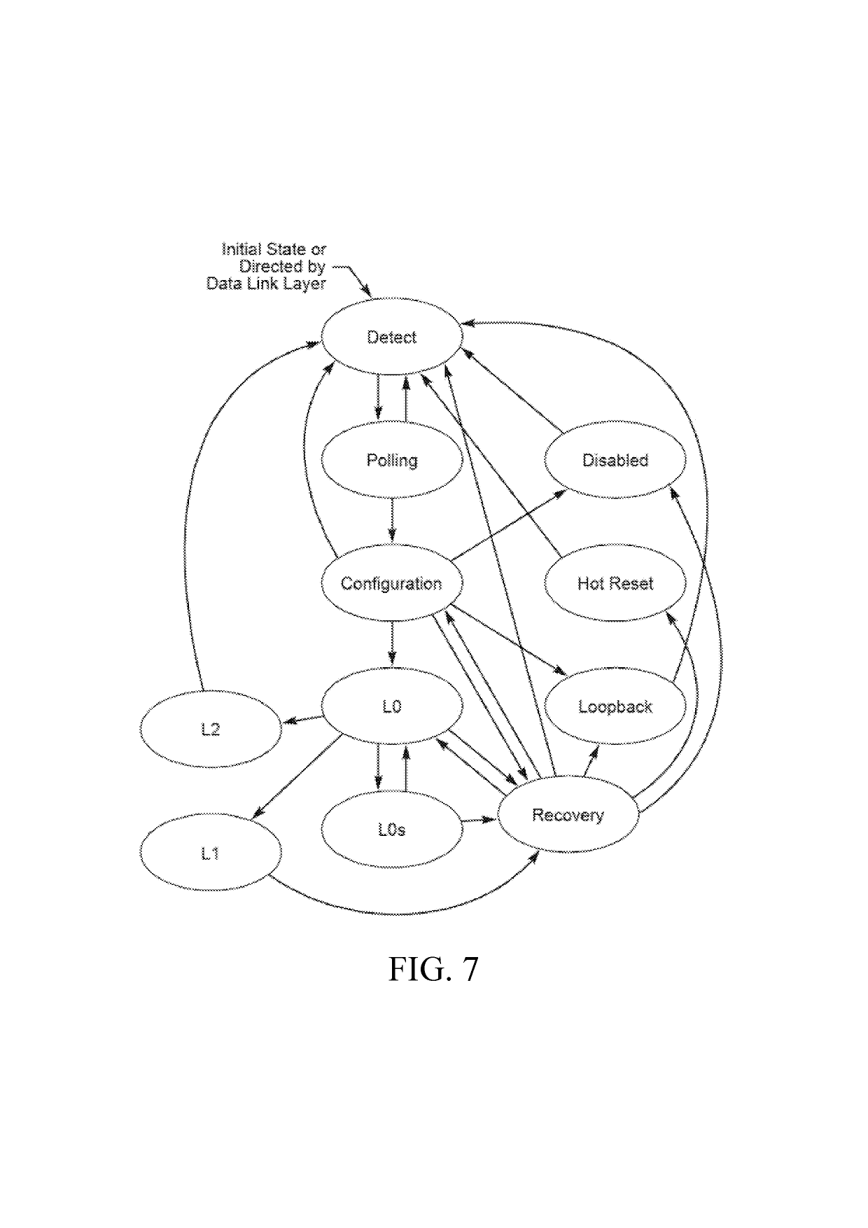

Compared with the LTSSM (as shown in FIG. 7) in an existing PCIe communication standard, the interface card device 10 is newly added with the reset state St0, thus when the link between the interface card device 10 and the host device 20 is abnormal (for example, the finite state machine cannot execute conversion of the next state due to electrical interference), the interface card device 10 can reset automatically to reconstruct the transmission channel between the interface card device 10 and the host device 20.

With reference to FIG. 7 to FIG. 9. In some embodiments, the transmission interface 100 can be an interface (i.e., a PCIe interface) conforming to the PCIe communication standard, such as but not limited to, a PCIe x1 interface, a PCIe x4 interface, a PCIe x8 interface or a PCIe x16 interface. Moreover, the slot of the host device 20 is a slot corresponding to the PCIe interface, such as but not limited to, a PCIe x1 slot, a PCIe x4 slot, a PCIe x8 slot or a PCIe x16 slot. That is, in some embodiments, the interface card device 10 is a PCIe device.

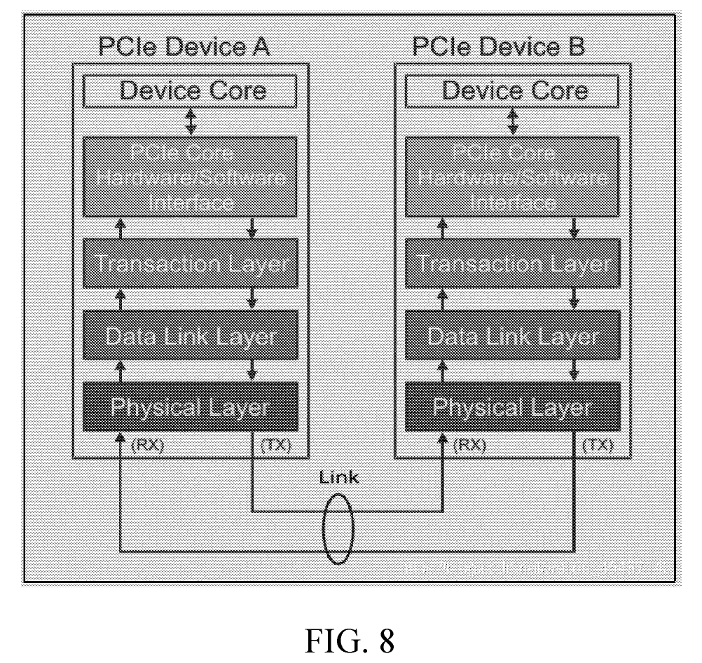

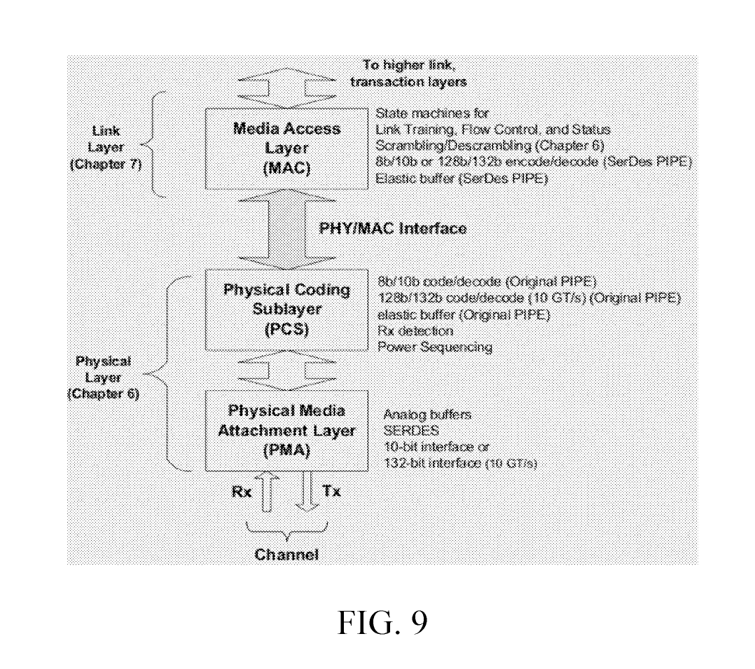

In the embodiment, the at least one layer of the transmission interface 100 includes a physical layer (PHY) (as shown in FIG. 8), and the PHY includes a physical coding sublayer (PCS), a physical media attachment layer (PMA) and a media access control layer (MAC) (as shown in FIG. 9). The PCS is positioned between the MAC and the PMA, and the finite state machine of the MAC is the link training and status state machine (as shown in FIG. 7). That is, various states defined in the link training and status state machine are suitable for the state of the finite state machine in the interface card device 10.

In some embodiments, the transmission interface 100 may further include a connector, and the connector is butted with the host device 20. The PMA is positioned between the PCS and the connector. For example, when the transmission interface 100 is the PCIe interface, the control module 120 will construct the transmission channel (i.e., the PCIe link or PCIe channel) between the interface card device 10 and the host device 20 through the link training and status state machine.

In some embodiments, the timing module 110 can be a hardware element with a timing function, such as but not limited to, a timer, a counter or a watchdog timer. When the timing module 110 is the watchdog timer, the timing module 110 has partial functions of the control module 120. For example, when the timing module 110 generates the reset signal (RST) and resets the state-stop time (corresponding to step S120), the timing module 110 can synchronously record related information of the error in the interface card device 10 or the host device 20 and the state of the finite state machine into the log file, and store the log file in the memory module 130.

In some embodiments, the control module 120 can be a hardware element with a control function, such as but not limited to, a central processing unit (CPU), a microprocessor, a digital signal processor (DSP), a complex programmable logic device (CPLD), a field programmable gate array (FPGA), application specific integrated circuits (ASICs) or a microcontroller unit (MCU).

In some embodiments, the memory module 130 can be a hardware device with a write function, such as but not limited to, a random access memory (RAM), a non-volatile memory or a flash memory.

In conclusion, according to the interface card device and the repair method thereof in any embodiment, the state-stop time is detected to confirm whether the interface card device is subjected to an error, and when the interface card device or the host device is subjected to the error, the state of the finite state machine in the transmission interface can be reset within a specific time (corresponding to the threshold), and thus the interface card device reconstructs the transmission channel relative to the host device so as to eliminate the error. In addition, besides immediately resetting the state, the interface card device and the repairing method thereof can also store the error (namely, the state that the error occurs), so that the user can obtain the information of the error to further perform subsequent analysis and debugging.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An interface card device, comprising:
a transmission interface, electrically connected to a host device and comprising at least one layer corresponding to at least one finite state machine;
a timing module, electrically connected to the transmission interface, and configured to time a state-stop time for any of the at least one finite state machine to stop working, and to generate a reset signal and reset the state-stop time when the state-stop time exceeds a threshold; and
a control module, electrically connected to the transmission interface and the timing module, and configured to switch a state of the at least one finite state machine, and to switch the state to a reset state according to the reset signal.

2. The interface card device according to claim 1, further comprising:
a memory module, electrically connected to the control module, and configured to store the state of the at least one finite state machine when the state-stop time exceeds the threshold.

3. The interface card device according to claim 1, wherein the state of the at least one finite state machine comprises a detection state, a polling state, a configuration state, a working state, a plurality of low-power-consumption states with different power consumption degrees and a reset state which are associated with each other.

4. The interface card device according to claim 1, wherein the at least one layer comprises a physical layer (PHY), the PHY comprises a physical coding sublayer (PCS), a physical media attachment layer (PMA) and a media access control layer (MAC), the PCS is positioned between the MAC and the PMA, and the finite state machine of the MAC is a link training and status state machine (LTSSM).

5. The interface card device according to claim 1, wherein the timing module is a watchdog timer.

6. The interface card device according to claim 1, wherein the interface card device is a PCIe device.

7. A repairing method of an interface card device, comprising:
monitoring a working of a finite state machine;
in response to that the finite state machine stops working, starting to time a state-stop time;
in response to that the state-stop time exceeds a threshold, generating a reset signal and resetting the state-stop time; and
switching a state of the finite state machine to a reset state according to the reset signal.

8. The repairing method according to claim 7, further comprising:
recording the state of the finite state machine when the state-stop time exceeds the threshold.

9. The repairing method according to claim 7, further comprising:
driving the finite state machine to start working; and
during the working of the finite state machine, sequentially switching the state of the finite state machine from a detection state to a polling state, a configuration state and a working state.

10. The repairing method according to claim 9, further comprising:
during the working of the finite state machine, switching the state of the finite state machine from the working state to one of a plurality of low-power-consumption states with different power consumption degrees.

11. The repairing method according to claim 10, further comprising:
during the working of the finite state machine, switching the state of the finite state machine back from one of the plurality of low-power-consumption states to the working state.

12. The repairing method according to claim 7, wherein the finite state machine is located in a PCIe device.
